(19) United States
(12) Patent Application Publication
(10) Pub. No.: US 2025/0068946 A1
(43) Pub. Date: Feb. 27, 2025

(54) EXPLAINABLE ENTROPY FOR ANOMALY DETECTION

(71) Applicant: Capital One Services, LLC, McLean, VA (US)

(72) Inventors: Samuel SHARPE, Cambridge, MA (US); Brian BARR, Schenectady, NY (US)

(73) Assignee: Capital One Services, LLC, McLean, VA (US)

(21) Appl. No.: 18/453,109

(22) Filed: Aug. 21, 2023

(51) Int. Cl. G06N 5/045; G06N 5/01

(52) U.S. Cl. CPC G06N 5/045; G06N 5/01

(57) ABSTRACT

A method and related system perform operations to obtain data points in a feature space for a set of input records, determine explainability parameters for the data points and a prediction model using an explainability model, and determine a score associated with a candidate data point of the data points based on a first set of values and a second set of values determined with the explainability parameters. Some embodiments may select the candidate data point based on a result indicating that the score satisfies a threshold and store, in a memory, an indication of a candidate record associated with the candidate data point.

### SUMMARY

Complex decision systems are used across a variety of applications in infrastructure, healthcare, and resource management. Understanding the basis for these decisions can provide important advances in understanding the underlying factors that drive a decision system to select one decision in lieu of others. This understanding can form the basis of relationship quantification between various factors that would otherwise go undetected.

However, predicting the output of complex decision systems and why a decision is made for any particular set of values can be a laborious and confusing endeavor. In many cases, especially with high-entropy datasets, highly similar records may be labeled with vastly different outputs by a decision system. Similarly, highly disparate sets of inputs may lead a decision system to categorize both records with the same output category. Such high-entropy datasets may prove problematic for decision model implementation. Thus, detecting such high-entropy portions of a dataset may prove advantageous for machine learning operations.

Some embodiments described in this disclosure may perform operations to overcome the above-described technical limitation or other issues to detect anomalous records using explainability-based entropy values. Some embodiments may obtain data points in a feature space for a set of input records and determine explainability parameters for the data points and a prediction model using an explainability model. For example, some embodiments may generate data points in a feature space for a set of input records. These data points may include feature values for a plurality of features in the feature space, where these feature values may include values directly acquired from the input record or values that are derived from one or more input record values. Some embodiments may then determine explainability parameters for the data points and a prediction model using an explainability model and then use the explainability models to detect anomalous records or other types of anomalous data.

Some embodiments may determine a score associated with a candidate data point of the data points based on a first set of values and a second set of values determined with the explainability parameters. For example, some embodiments may use the explainability parameter by determining one or more corresponding entropy values and then using the entropy values to determine anomalous data. In some embodiments, operations may include determining explainability parameters such that a respective parameter of the explainability parameters is associated with a respective feature of the plurality of features. Some embodiments may then determine a set of entropy values from the explainability parameters for a candidate data point representing a possibly anomalous data point, such as first and second entropy values. Some embodiments may provide an entropy model with a first subset of the explainability parameters associated with a first subset of the data points not including a candidate data point to determine the first entropy value. Similarly, some embodiments may provide the entropy model with a second subset of the explainability parameters associated with a second subset of data points including the candidate data point to determine the second entropy value.

Some embodiments may select a candidate data point as an anomalous data point based on a result indicating that the score satisfies a threshold and store, in a memory, an indication of a candidate record associated with the candidate data point. For example, some embodiments may select the candidate data point based on a result indicating that a calculated entropy difference score satisfies a threshold. Furthermore, some embodiments may indicate a candidate record associated with the candidate data point as anomalous by updating a collection of anomalous records to include the candidate record.

Various other aspects, features, and advantages will be apparent through the detailed description of this disclosure and the drawings attached hereto. It is also to be understood that both the foregoing general description and the following detailed description are examples and not restrictive of the scope of the invention.

### BRIEF DESCRIPTION OF THE DRAWINGS

Detailed descriptions of implementations of the present technology will be described and explained through the use of the accompanying drawings.

FIG. 1 illustrates a portion of an example system that uses explainability parameters to detect anomalies, in accordance with some embodiments.

FIG. 2 illustrates a table used to store values involved in detecting anomalies, in accordance with some embodiments.

FIG. 3 is a flowchart of operations for an exemplary method to detect anomalies in datasets, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

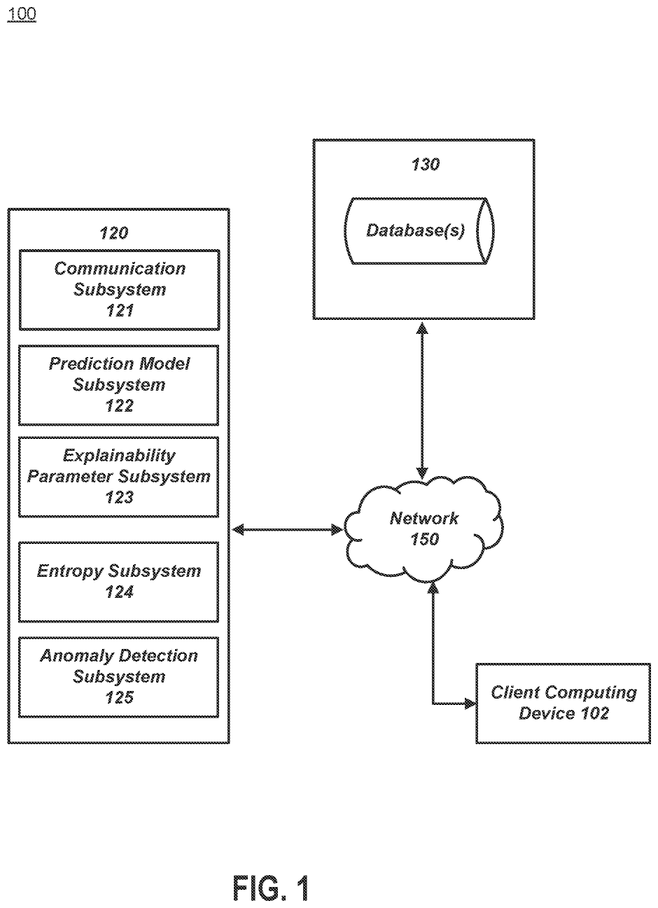

FIG. 1 illustrates a portion of an example system that uses explainability parameters to detect anomalies, in accordance with some embodiments. A system 100 includes a client computing device 102. The client computing device 102 may include various types of computing devices, such as a laptop computer, a desktop computer, a wearable headset, a smartwatch, another type of mobile computing device, etc. In some embodiments, the client computing device 102 may communicate with various other computing devices via a network 150, where the network 150 may include the Internet, a local area network, a peer-to-peer network, etc.

The client computing device 102 may send and receive messages through the network 150 to communicate with a server 120, where the server 120 may include a set of non-transitory storage media storing program instructions to perform one or more operations of subsystems 121-125. While one or more operations are described herein as being performed by particular components of the system 100, those operations may be performed by other components of the system 100 in some embodiments. For example, one or more operations described in this disclosure as being performed by the server 120 may instead be performed by the client computing device 102. Furthermore, some embodiments may communicate with an application programming interface (API) of a third-party service via the network 150 to perform various operations disclosed herein, such as training or using a prediction model, obtaining model parameters or other parameters used to compute an explainability parameter for the prediction model, or other operations described in this disclosure. For example, some embodiments may use an API to provide predictions with a prediction model by providing requests to a server accessible via the network 150.

In some embodiments, the set of computer systems and subsystems illustrated in FIG. 1 may include one or more computing devices having electronic storage or otherwise capable of accessing electronic storage, where the electronic storage may include the set of databases 130. The set of databases 130 may include values used to perform operations described in this disclosure, such as data associated with models or applications used to determine a prediction, explainability parameters, entropy values, other values of this disclosure, etc. For example, data objects of the set of databases 130 may include a set of records to be used as input records, input feature values, a set of explainability parameters, etc. Alternatively, or additionally, the set of databases 130 may include values determined using one or more operations described in this disclosure. For example, some embodiments may determine a set of entropy values based on explainability parameters determined for a data point and store the set of entropy values in association with the data point in the set of databases 130. Furthermore, as described elsewhere in this disclosure, some embodiments may store the set of entropy values in association with a data point by augmenting the data point with the set of entropy values for use as additional features of the augmented data point.

In some embodiments, the communication subsystem 121 may retrieve information such as model parameters of a prediction model, obtain values for an explainability model, obtain predetermined explainability parameters, etc. For example, the communication subsystem 121 may obtain a set of input feature values provided by the client computing device 102. The communication subsystem 121 may further send instructions to perform one or more actions or send data to other computing devices, such as the client computing device 102. For example, some embodiments may send one or more summarizations generated by the server 120 to the client computing device 102.

In some embodiments, a prediction model subsystem 122 may provide one or more predictions based on input data provided to the prediction model subsystem 122 (e.g., input data provided via the communication subsystem 121). The prediction model subsystem 122 may include one or more prediction models, such as a rules-based model, statistical model, tree-based model (such as a binary tree, random forest, etc.), Naïve-Bayes model, support vector machines model, or neural network model. For example, the prediction model subsystem 122 may include a deep learning neural network model that includes a convolutional neural network to perform operations and determine one or more predictions.

The prediction model subsystem 122 may output one or more various types of predictions. For example, the prediction model subsystem 122 may generate a category value as a prediction, where the categories from which the category value may be selected may include only two categories (e.g., “0” or “1”) or may include more than two possible categories (e.g., “accept,” “waitlist,” or “reject”). For example, some embodiments may provide values from a user record to a rules-based prediction model that uses rules to generate sub-outputs that are then used to categorize the user. Furthermore, the prediction model may be used to assign one or more predictions to a user, other entity, or set of entities identified or otherwise indicated by a record or set of records. For example, some embodiments may use a prediction model to output the value “stop activity” based on values from a first record corresponding with an account and, in response to outputting this prediction, some embodiments may stop transaction activity associated with the account. Alternatively, or additionally, some embodiments may use the prediction model to simulate outputs of a different model. For example, a prediction model of the prediction model subsystem 122 may include an ensemble neural network model that, after being provided with a first set of input values, is used to output a prediction of what a third-party model will output based on the same first set of input values or other input values associated with this first set of input values.

Some embodiments may use an explainability parameter subsystem 123 to determine one or more explainability parameters for a prediction model of the prediction model subsystem 122. For example, some embodiments may use an explainability model that includes a lying-based model to determine a set of explainability parameters corresponding with the input fields for the prediction model. As described elsewhere in this disclosure, the explainability parameters may indicate a relative importance of each parameter in arriving at a prediction for the prediction model. By providing explainability parameters, some embodiments may use the explainability parameters as inputs for calculating one or more entropy values. Alternatively, or additionally, some embodiments may compute entropy values without determining explainability values.

Some embodiments may use an entropy subsystem 124 to determine one or more entropy values for a data point or record associated with the data point. As described elsewhere in this disclosure, an entropy value may indicate a degree of randomness in a data subset. For example, a high value for entropy in a dataset indicates that relatively minor changes in the value of the dataset can induce significant changes in a prediction based on the dataset. Conversely, a low value for dataset entropy may indicate that relatively small changes in the input values for a prediction model based on the dataset are less likely to create unpredictable changes in the predictions made by the prediction model based on the dataset.

Some embodiments may use one or more various types of entropy values, where different types of entropy values may represent different operations used to determine the entropy value for that type. For example, the entropy subsystem 124 may include a Shannon entropy model usable to determine a Shannon entropy, a Gini impurity model to determine a Gini impurity value usable as an entropy value, or other types of entropy models, such as an ad-hoc entropy model created for a specific type of dataset or a specific prediction model. In some embodiments, the input for an entropy model may include explainability parameters or may otherwise be based on explainability parameters. For example, some embodiments may use explainability parameters to determine a probability distribution corresponding with the features of the inputs for a prediction model. Some embodiments may then use the probability distribution as inputs for an entropy model to determine a corresponding entropy value for a subset of data points that may then be assigned to one or more data points in the subset of data points.

In some embodiments, an anomaly detection subsystem 125 may be used to indicate one or more data points representing a record as anomalous based on the explainability parameters or the entropy values for a data point. For example, some embodiments may determine differences in entropy values between two data points. In some embodiments, the first data point may have been assigned a first entropy value based on a first subset of data points that includes the first data point. Similarly, the second data point may have been assigned a second entropy value based on a second subset of data points that includes the second data point. Some embodiments may then determine whether the difference between the two entropy values satisfies a difference threshold. For example, some embodiments may determine that a Euclidean distance between two data points in a feature space representing the entropy values is greater than a predetermined entropy value difference threshold and, in response, determine that at least one of the two data points is anomalous.

In some embodiments, the anomaly detection subsystem 125 may directly use explainability parameters to detect one or more anomalies. For example, some embodiments may determine changes in an explainability parameter space for different subsets of data points, where the explainability parameter space for a set of data points may represent the domain of the explainability parameters generated for a prediction model based on the set of data points. Based on a determination that changes in the explainability parameter space exceed a threshold, some embodiments may then indicate one or more anomalies. For example, as described elsewhere in this disclosure, some embodiments may determine a respective set of explainability parameters for each data point of a data point set. Some embodiments may then determine whether differences between the explainability parameters between one data point and a second data point exceed a threshold, where the differences may be represented as a distance in a parameter space (e.g., Manhattan distance, Euclidean space distance, etc.). In response to a determination that the difference exceeds a threshold, some embodiments may then indicate at least one or both of the data points as anomalies.

Furthermore, some embodiments may use augmented data points that include both values of a record and explainability parameters for a prediction model based on those values to determine whether one or more data points or records associated with those one or more data points should be indicated to be anomalies. For example, some embodiments may determine a first set of explainability parameters for a first data point using one or more operations described in this disclosure. Some embodiments may then generate an augmented data point by including the first set of explainability parameters with the first data point. Some embodiments may then use the same process to generate a set of augmented data points corresponding with the data points of an initial dataset for a prediction model. Some embodiments may then determine differences between the augmented data points or perform clustering operations on the augmented data points, where distance is computed based on the differences or clusters of the augmented data points and may be used to determine one or more anomalous data points.

In response to a determination that the difference satisfies the difference threshold, some embodiments may indicate one or both of the corresponding data points used to determine the entropy value difference as anomalous. For example, some embodiments may tag a first data point or a first record used to generate the first data point with an additional indicator to represent the first data point or the first record, where the indicator may be represented by an additional field value for the record, an additional element in a vector representing the data point, etc.

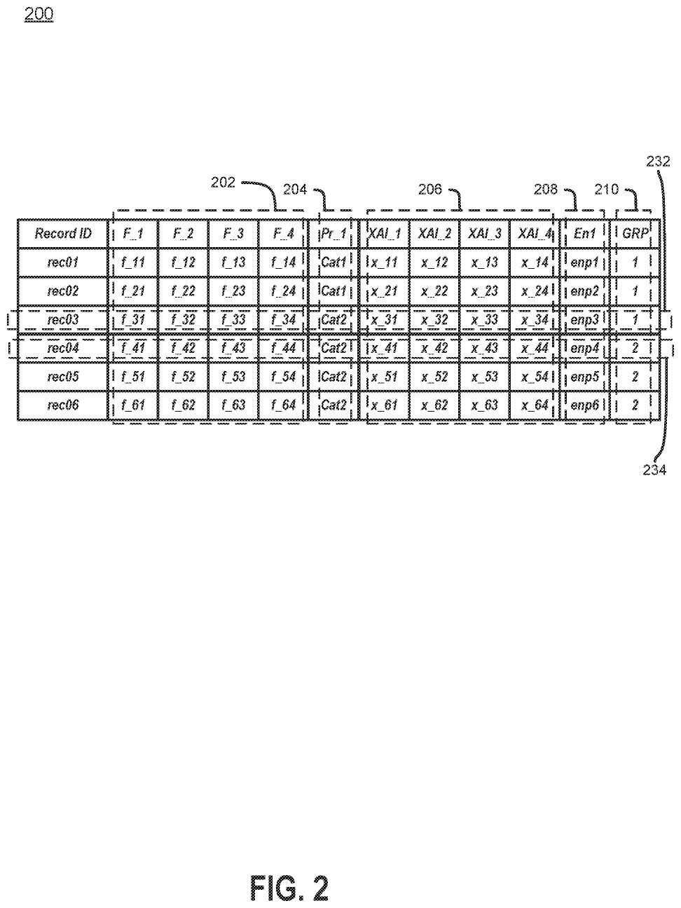

FIG. 2 illustrates a data structure 200 used to store values involved in detecting anomalies, in accordance with some embodiments. The data structure 200 indicates different values corresponding with input feature values, predictions generated from the input feature values, explainability parameters for the input features, entropy values, and record subset identifiers. The data structure 200 includes a first set of columns 202, where values and the first set of columns 202 include feature values for the corresponding features “F_1,” “F_2,” “F_3,” and “F_4.” The data represented by values in the first set of columns 202 may be provided to a prediction model to generate predictions presented in a prediction column 204. Some embodiments may assign a set of clusters based on the values shown in the first set of columns 202 or the prediction column 204.

Some embodiments may use the data stored in the first set of columns 202 and the corresponding output data in the prediction column 204 that is generated from the data in the first set of columns 202 and then determine a set of explainability parameters presented in a set of columns 206. As shown in the data structure 200, each column of the first set of columns 202 may have a corresponding column in the set of columns 206. The explainability parameters represented by the set of columns 206 may be represented by vectors in a corresponding explainability parameter space. Additionally, some embodiments may use clustering operations to generate clusters in the explainability parameter space to form explainability parameter space clusters. Some embodiments may determine that one or more clusters of the explainability parameter space clusters represent non-anomalous data, where the selection may be user-assigned or may be based on a set of criteria. For example, some embodiments may determine that a majority of the explainability parameter space data points in a first explainability parameter space cluster is associated with the same prediction. Some embodiments may then determine that a candidate explainability parameter space data point, which was generated from a corresponding candidate data point with an explainability model, is associated with the same prediction but is not part of the first explainability parameter space cluster but is instead part of a second explainability parameter space cluster. In response to determining that the candidate explainability parameter space data point is not associated with the first explainability parameter space cluster, some embodiments may indicate the candidate data point or a record used to generate the candidate data point as anomalous.

Some embodiments may then use the data in the set of columns 206 to determine entropy values presented in an entropy value column 208. Furthermore, some embodiments may use the values of the records presented in the first set of columns 202 in combination with a clustering algorithm to determine clusters based on the first set of columns 202. For example, as shown in a column 210, a data point of the record “rec01” may be assigned to a first cluster identified by the numeric value 01.

Some embodiments may perform operations to determine that a record is anomalous based on information shown or derived from the data presented in the data structure 200. Various types of operations may be used to determine that one or more records are anomalous. For example, some embodiments may determine that at least one data point of a pair of data points is anomalous based on discrepancies between how similar the pair of data points are when compared in a feature space of the data points and how different the data point pair are in their corresponding explainability parameter space. A set of discrepancy criteria may be implemented as a first criterion such that a distance in feature space between a candidate data point and a data point classified as non-anomalous is less than a feature space threshold but that a distance in parameter space between a candidate data point and a data point classified as non-anomalous is greater than a parameter space threshold. Alternatively, some embodiments may combine the feature and explainability parameter spaces into an augmented feature space to determine a distance in the augmented feature space and determine that a candidate data point is anomalous based on a determination that the distance in the augmented feature space is greater than an augmented feature space threshold.

As an example, some embodiments may determine that the feature values of the first set of columns 202 corresponding with a row 232 are values of a first data point in feature space for the record “rec03” represented by the row 232. Similarly, the feature values of the first set of columns 202 corresponding with a row 234 are values of a second data point in feature space for the record “rec04” represented by the row 234. Some embodiments may obtain user input or other information that the record “rec03” represents a non-anomalous record. Some embodiments may then determine that the feature space difference between the first data point in feature space and the second data point in feature space is less than a feature space threshold. Some embodiments may also determine that the explainability parameter space values of the set of columns 206 corresponding with the row 232 are values of a first data point in the explainability parameter space for the record “rec03” represented by the row 232. Similarly, the explainability parameter space values of the set of columns 206 corresponding with the row 234 are values of a second data point in the explainability parameter space for the record “rec04” represented by the row 234. Some embodiments may then determine that the parameter space difference between the first data point in explainability parameter space and the second data point in explainability parameter space is greater than an explainability parameter space threshold. Based on this discrepancy, some embodiments may indicate that the second data point or the record associated with the second data point, the record having the record ID “rec04,” is anomalous.

Some embodiments may determine a set of entropy values corresponding with a data point or set of data points. For example, some embodiments may use a method inspired by the general entropy formula, Entropy=−Σ(p*log₂(p)), where probability values p may be substituted by explainability parameters or be otherwise related to explainability parameters. Alternatively, or additionally, some embodiments may use other operations to determine entropy values for a data point, such as by determining the entropy value of a cluster in which a candidate data point is assigned and then assigning that entropy value to the candidate data point. Based on changes in the entropy value between a pair of data points, some embodiments may label one or both of the pair of data points as anomalous. For example, some embodiments may determine that a first data point is a non-anomalous data point based on a determination that the first data point is part of a subset of data points labeled as non-anomalous by a user or oracle. Some embodiments may then determine that the second data point is anomalous based on a determination that a difference in the entropy value of the first data point and an entropy value of the second data point is too great. For example, some embodiments may calculate a difference between the entropy value “enp3” shown for the record represented by row 232 and the entropy value “enp4” shown for the record represented by row 234, where the record represented by the row 232 may have been labeled as non-anomalous. Some embodiments may use this difference as an entropy difference score and compare the entropy difference score to an entropy difference threshold. Based on a determination that the entropy difference threshold is satisfied, some embodiments may determine that the record represented by the row 234 is anomalous.

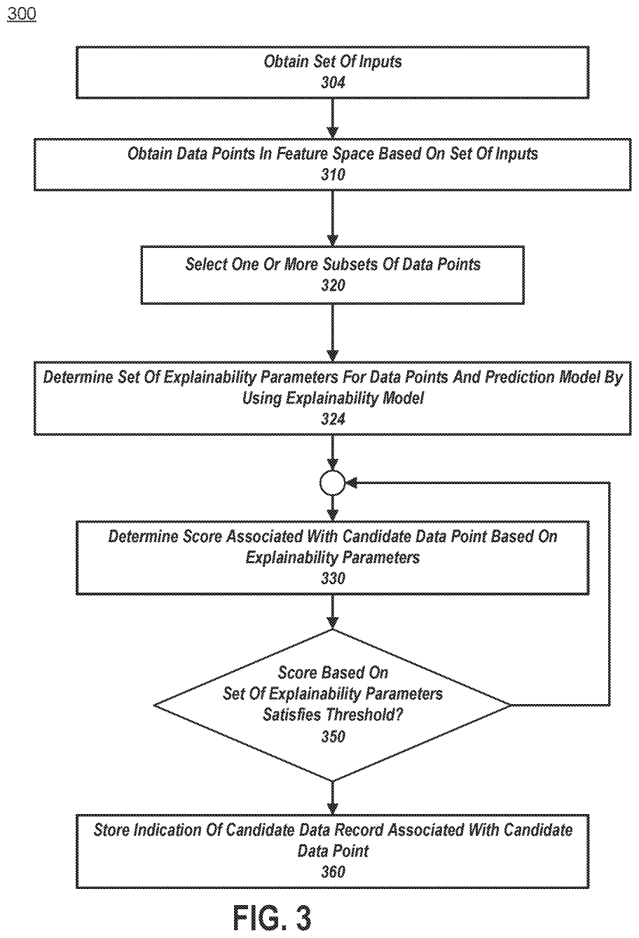

FIG. 3 is a flowchart of operations for an exemplary method to detect anomalies in datasets, in accordance with one or more embodiments. Some embodiments may obtain a set of inputs, as indicated by block 304. In some embodiments, the set of inputs may be obtained in the form of records to be used as inputs or from which the set of inputs are derived. The set of input records may be obtained directly from a user via a terminal or other user interface displayed on a client computing device. Alternatively, some embodiments may obtain a set of input records from a database or other data structure. As used in this disclosure, a record may include a database record of a structured database system. A record may also include other types of collections of related data, where such a collection represents or otherwise characterizes a single entity. For example, some embodiments may retrieve a set of database records assigned for use as a training model, where the set of database records may be used as a set of input records. Alternatively, or additionally, some embodiments may obtain a set of input records from a third-party data source via an API. For example, some embodiments may obtain a set of input records from a data service via an API of the data service.

An input record for an entity may include a set of values characterizing the entity. For example, a record for a customer may include values that represent the customer's income, the customer's age, the customer's credit score, the customer's amount stored in a bank account, the customer's loan amount, a number of times the customer had accessed a bank account in a predetermined duration, a duration for a loan or other time-related information, etc.

Some embodiments may obtain data points in a feature space based on the set of inputs, as indicated by block 310. In some embodiments, the data points in the feature space for the set of inputs may include values directly stored in a set of input records, such as numeric values, categorical values, or other values that are quantifiable. Alternatively, or additionally, some embodiments may generate derived values using a set of operations by using one or more of the values of the set of input records as inputs for the set of operations. For example, some embodiments may generate a data point for a user based on the user record, where the user record includes a first subset of values and a second subset of values. The first subset of the values of the data point may be directly retrieved from the user record such that they match with values of the user record. The second subset of the values of the data point may be obtained by providing one or more values of the user record to a set of functions or applications and using the outputs of the functions or applications as values of the data point.

Some embodiments may perform transformation operations on values of the set of input records and use the transformation outputs as values of data points. For example, some embodiments may normalize or rescale one or more feature values of a set of user records before using the normalized or otherwise rescaled values in a corresponding set of data points. For example, some embodiments may retrieve a record for a first user having a feature value “23” for a first feature representing the user's income. Some embodiments may transform this value by normalizing this feature value with the normalization constant 100 to determine the normalized feature value “0.23.” To perform a transformation, some embodiments may use one or more mathematical operations such as, though not limited to, addition, multiplication, subtraction, division, exponentiation, squaring, root determination, logarithm determination, etc. Some embodiments may perform other operations to transform values of a set of inputs, such as by performing a one-hot encoding operation on feature values.

Some embodiments may further perform operations to dimensionally reduce values of a set of input records before providing the values to a prediction model. For example, some embodiments may determine an intermediate set of data points, where the intermediate set of data points may include at least one value that is directly stored in the set of input records or include values derived from transformations of the set of input records. Some embodiments may then dimensionally reduce the intermediate set of data points to determine a final set of data points to be used for anomaly detection or other operations described in this disclosure. Some embodiments may perform dimensionally reducing operations such as feature selection operations, principal component analysis, or other dimensionally reducing operations to determine a dimensionally reduced set of data points for use as an input set of data points that is to be provided to a prediction model.

Some embodiments may perform operations to compensate for a missing set of values, mislabeled values, or otherwise inaccurate or incomplete information. For example, some embodiments may determine that a record from a set of records obtained from a database is missing a set of values by applying a set of data-checking criteria to the obtained records. Some embodiments may perform operations to fill in the missing information with synthesized values. In some embodiments the values used to fill in the missing information may be a predetermined value. Alternatively, or additionally, some embodiments may fill in the missing information based on other records obtained from the same database or a different data store. For example, some embodiments may determine one or more neighboring records associated with the record that is indicated to be missing one or more values.

Some embodiments may determine the neighboring set of records by examining distances in one or more non-missing features of the first record and feature values of other obtained records. Some embodiments may then use the values in this neighboring set of records to determine a boundary region representing the balance of values that a value of a missing field of the first record is likely to be within. For example, if a minimum non-missing field value of a neighboring set of records is 0.2 and a maximum non-missing field value of the neighboring set of records 0.8, some embodiments may limit synthesized data for this missing field to also be between 0.2 and 0.8. Some embodiments may then use a random or pseudorandom method to generate a synthesized value to substitute in for the missing value of the first record to generate a synthesized data point associated with the first record. Some embodiments may then repeat this operation for one or more other records having missing feature values. After generating a subset of synthesized data points, some embodiments may then use the subset of synthesized data points in conjunction with other data points described in this disclosure to detect the presence of one or more anomalous records.

Some embodiments may select one or more subsets of data points, as indicated by block 320. In some embodiments, scores determined for a subset of data points may be assigned to a candidate data point in the subset. For example, an explainability parameter determined for a subset may be used as the corresponding explainability parameter for that subset. Different subsets of data points may be used to determine whether a candidate data point in at least one of the different subsets of data points should be marked for further analysis as a result of an entropy value associated with the candidate data point.

Some embodiments may select a dataset for use as a subset based on data point clusters generated with the use of clustering algorithms. For example, some embodiments may perform clustering operations to determine whether a particular data point belongs in an existing cluster and assign the particular data point to the existing cluster or whether the particular data point should be used to generate a new cluster or be otherwise isolated from existing clusters in a dataset. Some embodiments may use a clustering algorithm such as a K means clustering algorithm, density-based clustering algorithm, mean shift clustering algorithm, darshan mixture model algorithm, spectral clustering algorithm, or hierarchical clustering, etc. After determining clusters for a dataset such that each data point of a subset is determined to share a data point cluster, some embodiments assign values determined based on collective data of the shared data point cluster to each respective data point in the shared data point cluster. For example, after determining a set of entropy values for a shared data point cluster, some embodiments may assign or otherwise associate the set of entropy values to the selected data point.

In some embodiments, as described elsewhere in this disclosure, a computer system may determine a set of data point clusters that includes a first data point cluster and a second data point cluster using a density-based clustering algorithm. For example, some embodiments may obtain a density parameter and a reference data point, where the density parameter or the reference data point may be predetermined, randomly selected, provided by a user in a terminal or other user interface, etc. Some embodiments may then determine a set of neighboring data points of the reference data point based on the density parameter. The computer system may then select the data points for a first subset of data points as the same data points of the first data point cluster, where each respective data point of the first subset of data points is a data point of the first data point cluster. Some embodiments may then determine the data points for a second subset of data points as a same data points of the second data point cluster, where each respective data point of the second subset of data points is a data point of the second data point cluster.

Some embodiments may determine a set of explainability parameters for the data points and a prediction model by using an explainability model, as indicated by block 324. As described elsewhere in this disclosure, some embodiments may use a prediction model to provide one or more predictions based on a set of inputs that includes the data points associated with a set of input records. For example, some embodiments may obtain neural network parameters and configure a prediction model that includes a deep learning network with the neural network parameters. Some embodiments may then provide a set of candidate inputs to the prediction model to determine a corresponding set of candidate outputs provided by the prediction model and use the set of candidate inputs and outputs to determine a set of explainability parameters. Furthermore, some embodiments may determine explainability parameters for subsets of data points and associate the explainability parameters for a data point subset to each of the data points in the data point subset.

One or more types of explainability models may be used to determine a set of explainability parameters for a prediction model, where each respective parameter of the set of explainability parameters corresponds with a respective field of a data point provided to the prediction model. For example, some embodiments may use a surrogate method to determine explainability parameters, such as a method inspired by Shapley Additive Explanations (SHAP) operations to determine a corresponding set of Shapley values for use as explainability parameters. To use a SHAP-inspired method and to determine a set of Shapley values for use as explainability parameters, some embodiments may first determine a feature space region based on neighboring data points of a first data point. For example, to determine a feature space region for a first data point, some embodiments may establish a feature space region in a multidimensional hypersphere that includes a preestablished number of neighboring data points of the first data point. Some embodiments may then perturb the feature values of the first data point within this feature space region to generate a set of perturbation data points. Some embodiments may then provide the perturbation data points to a prediction model to generate a corresponding set of predictions and use the perturbation data points and corresponding set of predictions to determine a set of marginal contributions corresponding to each feature.

When determining the set of marginal contributions, some embodiments may use the feature values of a predetermined data point as a reference point for comparison with respect to changes in the predictions. Alternatively, some embodiments may use feature values of the first data point as a reference point for comparison with respect to changes in the predictions. Some embodiments may then determine an expectation value of or some other measure of central tendency for each marginal contribution to determine a marginal contribution of a feature, where these expectations may, in some embodiments, be weighted by a conditional likelihood of a particular value. Some embodiments may then use conditional expectation values or other measure of central tendencies determined from marginal contributions for a feature as an explainability parameter for the feature.

Alternatively, or additionally, some embodiments may use other surrogate models, such as a local interpretable model-agnostic explanations (LIME) model, to determine a set of explainability parameters for a set of data points. For example, to determine the explainability parameters for a prediction model around a particular data point, some embodiments may perturb the values around the data point to generate perturbation data points. To determine the region within which the perturbation data points may be created, some embodiments may obtain a set of feature value boundaries for one or more features of a feature space representing a universe of values for a set of data points. For example, some embodiments may obtain the feature value boundaries (0, 10) for a first feature to represent that the first feature may vary between the values of 0 and 10. Some embodiments may then obtain a data point to determine whether the data point should be treated as a candidate data point for further study. For example, a computer system may obtain a data point having a first feature value equal to 0.5, where the first feature value is bounded by the feature value boundaries (0, 1.0). The computer system may then perturb one or more feature values of a data point to determine a set of perturbation data points. For example, the computer system may perturb the first feature value 0.5 to the value 0.52, where the set of perturbation data points may include only one data point or may include more than one data point. In some embodiments, the perturbation may be further limited to a kernel width, where the kernel width may correspond with one dimension of a feature space or multiple dimensions of the feature space. For example, even if a feature value boundary requires that feature values of a first feature be between 1.5 and 2.5, some embodiments may further limit perturbations to a data point for that first feature with a kernel width the value of 0.1, such that perturbations to a data point having a first feature value equal to 2.0 may only perturb within the range of 1.9 to 2.1.

Some embodiments may then provide the perturbation data points to a prediction model to generate corresponding predictions and then use the perturbation data points and the corresponding predictions as a synthetic dataset. Some embodiments may then fit the interpretable model, such as a linear regression or decision tree model, to the synthetic dataset. Some embodiments may then determine the feature importance of each feature for a particular data point based on the parameters of the fitted interpretable model. In some embodiments, the explainability parameters for a feature may be equivalent to the fitted interpretable model parameters. Alternatively, an explainability parameter for a feature may be derived from a fitted interpretable model parameter for the explainability parameter. In some embodiments, each data point in a feature space may have its own corresponding set of fitted interpretable model parameters and thus may be associated with its own respective set of explainability parameters.

Some embodiments may use methods of determining a set of explainability parameters corresponding with a specific data point. For example, some embodiments may use methods inspired by integrated gradients to determine explainability. In some embodiments, a computer system may determine a point-specific set of explainability parameters for a first data point, where determining the point-specific set of explainability parameters for the first data point may be performed by obtaining a default set of features from an initial designated point in a feature space, where the feature space represents the features of a data point. For example, if a data point has 10 fields, the feature space may include 10 corresponding dimensions. Some embodiments may then determine a path from the default set of feature values to a first data point in the feature space and perform a set of integration operations over the dimensions of the feature space along the path. For example, some embodiments may determine a set of integrals for a 100-dimensional feature space by integrating along each dimension of the feature space to determine, for that respective feature, a respective integral of partial derivatives. Some embodiments may then determine a point-specific set of explainability parameters based on the set of integrals by either directly using the set of integrals as explainability parameters or providing the set of integrals to another set of operations as an input for the set of operations.

After determining a set of perturbation data points, some embodiments may then determine a corresponding set of predictions for the set of perturbation data points. For example, some embodiments may determine a first prediction for a first data point using a production model and perturb the first data point to obtain a set of perturbation data points. After perturbing the first data point to determine the set of perturbation data points, some embodiments may then provide each of the perturbation data points to the prediction model to determine a set of predictions provided by the prediction model. Some embodiments may then use the output predictions corresponding with the perturbation data points in conjunction with the original prediction corresponding with the first data point to determine a set of explainability parameters associated with the first data point.

Some embodiments may adapt explainability models for tree-based decision systems. For example, some embodiments may use a prediction model that includes a tree-based model. Some embodiments may then use a tree-based SHAP model to determine a set of explainability parameters for the tree-based model. For example, some embodiments may traverse the tree-based model or multiple paths of the tree-based model to determine an initial set of Shapley values associated with nodes of the tree-based model. Some embodiments may then aggregate one or more of the Shapley values of the child nodes of the tree-based model with one or more of their corresponding parent nodes. Some embodiments may then treat these aggregated values as parameter values of a set of explainability parameters for the tree-based model or otherwise compute the explainability parameters based on the aggregated values.

Some embodiments may determine a score associated with a candidate data point based on the explainability parameters, as indicated by block 330. A candidate data point may be a candidate for analysis and labeling operations based on a determination that the candidate data point is associated with a score that satisfies a score threshold. A score based on an explainability parameter may include a difference in an explainability parameter space, an entropy value, a difference between entropy values, etc. Using different types of scores or criteria with which to judge the scores may result in correspondingly different definitions for anomalous data points with respect to the importance or interpretation of the effects of explainability parameters on whether a data point is an anomaly.

Some embodiments may determine a set of entropy scores for a set of data points and use the entropy scores to determine whether one or more of the corresponding set of data points is anomalous. In some embodiments, satisfying the score threshold may indicate that a particular data point has a high degree of entropy and should be assigned to a labeling operation or otherwise designated for a greater level of analysis due to the possibility that the candidate data point is indicative of a set of parameters susceptible to causing a change in prediction in response to a relatively small change in the values of the candidate data point. Alternatively, other types of scores may be used, such as a score representing a distance in a feature space or in an explainability parameter space. As discussed elsewhere in this disclosure, some embodiments may use the scores to detect discrepancies between closeness in feature space and closeness in explainability parameter space to indicate one or more data points for further review.

In some embodiments, the score may represent an entropy difference score, where the entropy difference score may represent a difference between a first set of entropy values and a second set of entropy values. In some embodiments, the set of explainability parameters may be directly used as a set of entropy values. As described elsewhere in this disclosure, entropy values represent a degree of predictability for a dataset. Entropy values may be computed in various ways, where such operations may rely on one or more types of entropy models. For example, some embodiments may determine explainability-based entropy values by using entropy models that determine entropy values by using, as inputs or model parameters, explainability parameters. Some embodiments may determine the first entropy value by providing an entropy model with a first subset of the set of explainability parameters, where the first subset of the explainability parameters is associated with data points that do not include the candidate data point. Some embodiments may determine the second entropy value by providing the entropy model with a second subset of the set of explainability parameters, where the second subset of explainability parameters is associated with data points that include the candidate data point.

Various types of entropy models may be used to determine entropy values based on explainability parameters. For example, some embodiments may use a Shannon model (or another type of model associated with the use of probability distributions) as an entropy model to determine entropy values. A computer system may use a probability model by determining a probability distribution of a set of explainability parameters by binning each parameter of the first subset of the explainability parameters into a corresponding set of bins. Some embodiments may then determine a distribution characteristic for this probability distribution, such as by determining a standard deviation, median, another measure of central tendency, another measure of dispersion, or another value characterizing the probability distribution. Some embodiments may then use the distribution characteristic as an entropy value.

Some embodiments may use this probability model to determine a first entropy value corresponding with a first set of data points and to determine a second entropy value corresponding with a second set of data points. For example, some embodiments may perform binning operations on a first set of explainability parameters corresponding with a first subset of data points and on a second set of explainability parameters corresponding with a second subset of data points to determine, respectively, a first probability distribution and a second probability distribution. Some embodiments may determine first and second entropy values based on the first and second probability distributions and then determine a score based on the first and second entropy values using operations described in this disclosure.

For example, some embodiments may further modify a Shannon model or other probability-based model to determine an entropy value. Some embodiments may obtain a set of parameter values for the entropy model, where the parameter value may be used to modify one or more outputs of the entropy model. For example, in some embodiments, a computer system may determine values for a set of bins by binning values of a set of explainability parameters and then determine a set of exponentials based on the values of the set of bins and the obtained set of parameter values. The set of parameter values may be used as a set of exponents. For example, in some embodiments, a computer system may determine an exponential for a particular bin of a set of bins, where the particular bin is represented by the value “0.1” and a count assigned to the particular bin is equal to “10.” The computer system may then obtain the model parameter value “2” and determine the exponential “100” by using “10” as the base and “2” as the exponent. Some embodiments may determine a first entropy value based on a first subset of exponentials determined from a first subset of explainability parameters and determine a second entropy value based on a second subset of exponentials determined from a second subset of explainability parameters. Some embodiments may then determine a difference between the first and second entropy values for use as an entropy difference score.

As discussed elsewhere in this disclosure, some embodiments may use other types of scores to determine whether or not to indicate a data point for further analysis. For example, some embodiments may determine a first distance in feature space region between a first data point and a second data point, where the first data point may be tested for use as a candidate data point for further indication or tagging. Some embodiments may determine a distance using one or more distance-measuring methods, such as a Manhattan distance, a Euclidean distance, etc. Some embodiments may determine multiple distances between a candidate data point and other data points of a dataset in a feature space. Furthermore, some embodiments may determine a distance in an explainability parameter space between a first set of explainability parameter values corresponding with the first data point and a second set of explainability parameter values corresponding with the second data point. Some embodiments may then compare the distance in the feature space with a feature space threshold and compare the distance in the explainability parameter space with an explainability parameter space threshold. Some embodiments may then determine whether a discrepancy exists based on the set of results indicating whether the feature space threshold is satisfied or whether the explainability parameter space threshold is satisfied. For example, some embodiments may determine that a feature space threshold is satisfied by a feature space distance involving a candidate data point but that an explainability parameter space threshold is not satisfied by an explainability parameter space associated with the candidate data point. In response to this discrepancy, some embodiments may tag the candidate data point or otherwise indicate the candidate data point.

Some embodiments may determine a set of scores for one or more data points by using explainability parameters of the one or more data points without being required to use entropy values. For example, in some embodiments, the score may be or otherwise include a distance value or set of distance values in the explainability parameter space. For example, some embodiments may determine a first distance as the distance in an explainability parameter space between the explainability parameters for a first record and the explainability parameters for a second record, where this first distance may be used as a first score. The distance may be computed using operations such as a Manhattan distance, a Euclidean distance, etc. Some embodiments may then determine a second distance as the distance in the feature space between the feature values for the first record and the feature values for the second record, where this second distance may be used as a second score. In some embodiments, the first and second score may be assigned to the first record. Alternatively, or additionally, the first score may be assigned to the second record.

Some embodiments may combine the feature values with the explainability parameter values for a record to determine an augmented data point for the record. For example, some embodiments may generate a set of explainability parameters for a prediction model, where the prediction model is provided with a first set of input values obtained from a record. Some embodiments may then generate an augmented data point that includes the first set of input values and the generated set of explainability parameters, where the domain of the augmented data point may be described as being in an augmented feature space. The augmented feature space may be described as including both the feature space of the first set of input values and the generated set of explainability parameters. Some embodiments may then generate a set of augmented data points based on a set of initial data points by performing similar operations for each respective data point of the set of initial data points.

After generating a set of augmented data points, some embodiments may then perform operations on these augmented data points similar to or the same as operations described for other data points described in this disclosure. For example, some embodiments may determine a distance for each respective data point with at least one other data point in the set of augmented data points or another point in the augmented feature space of the set of augmented data points. For example, some embodiments may determine a score for a first data point based on a distance between a first augmented data point corresponding with the first data point and a second augmented data point, where the distance is calculated in the augmented feature space.

Furthermore, clustering operations described for data points may be applicable to augmented data points. For example, some embodiments may determine subsets of augmented data points using a clustering algorithm and then determine if the subsets of augmented data points are distinct with respect to their corresponding predictions made by a prediction model. For example, some embodiments may determine that a subset of augmented data points in a first cluster of augmented data points is categorized with the prediction “permitted” and that a subset of augmented data points in the first cluster of augmented data points is categorized with the prediction “denied.” Some embodiments may then determine that a second cluster of augmented data points may be categorized with the prediction “denied.”

Some embodiments may determine whether a score determined from a set of explainability parameters satisfies a threshold, as indicated by block 350. In some embodiments, the threshold may be a predetermined value, where the threshold may represent a maximum permissible entropy. For example, some embodiments may determine a result representing whether the score is greater than the maximum permissible entropy. As described elsewhere in this disclosure, some embodiments may perform additional operations in response to a result indicating that the score is greater than the maximum permissible entropy. In cases where a score representing an entropy difference score is determined to be greater than the threshold, some embodiments may determine that the transition in entropy between neighboring data points is too great and thus that at least one of the data points should be marked for further analysis or training operations.

Some embodiments may store an indication of the candidate record represented by or otherwise associated with the candidate data point in a set of non-transitory, machine-readable media, as indicated by block 360. Some embodiments may indicate that the candidate records are associated with scores that exceed a threshold or anomalous records. Some embodiments may indicate that this collection of anomalous records should be examined by a user or analysis system. For example, some embodiments may store pointers, record identifiers, or other indicators of each record in a collection of anomalous records in a data subset that is sent to a designated analysis system via an online development platform. The designated analysis system may then perform operations to perform additional feature analysis operations based on the collection of anomalous records.

As described elsewhere, some embodiments may cause a user interface on a client device in direct or indirect communication with a database storing an indicated candidate record to display values of the record. For example, some embodiments may cause a user interface on a user device to present a row of a data table that represents the record. Furthermore, some embodiments may indicate the features of a record deemed to be most influential for a prediction made based on the record, where the influence of the features may be assessed based on their corresponding explainability parameters. For example, some embodiments may select a feature of a candidate record indicated to be anomalous based on a determination that the selected feature is associated with the greatest explainability parameter of the set of explainability parameters of the candidate record. In response, some embodiments may display the explainability parameter. Alternatively, or additionally, some embodiments may visually indicate features having explainability parameters that are greater than an explainability parameter display threshold. Visually indicating a feature may include providing a name of the feature, highlighting a feature, displaying an animation associated with the feature, outlining the feature with a different color relative to other features, etc.

Some embodiments may receive new information associated with a candidate data point that associates the candidate data point with a new label or otherwise updates one or more values of the candidate data point. For example, some embodiments may receive information from an oracle or a user indicating that a candidate data point should be associated with the label “denied” instead of the label “accepted.” In response, some embodiments may retrain the prediction model based on the values of the candidate data point and the new label provided by the user.

The operations of each method presented in this disclosure are intended to be illustrative and non-limiting. It is contemplated that the operations or descriptions of FIG. 3 may be used with any other embodiment of this disclosure. In addition, the operations and descriptions described in relation to FIG. 3 may be done in alternative orders or in parallel to further the purposes of this disclosure. For example, each of these operations may be performed in any order, in parallel, or simultaneously to reduce lag or increase the speed of a computer system or method. In some embodiments, the methods may be accomplished with one or more additional operations not described, and/or without one or more of the operations discussed. Additionally, the order in which the processing operations of the methods described in this disclosure is not intended to be limiting.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a set of non-transitory, machine-readable media, such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods. For example, it should be noted that one or more of the devices or equipment discussed in relation to FIG. 1 could be used to perform one or more of the operations in FIG. 3.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In some embodiments, the various computer systems and subsystems illustrated in FIG. 1 may include one or more computing devices that are programmed to perform the functions described herein. The computing devices may include one or more electronic storages (e.g., the set of databases 130), one or more physical processors programmed with one or more computer program instructions, and/or other components. For example, the set of databases may include a relational database such as a PostgreSQL™ database or MySQL database. Alternatively, or additionally, the set of databases 130 or other electronic storage used in this disclosure may include a non-relational database, such as a Cassandra™ database, MongoDB™ database, Redis database, Neo4j™ database, Amazon Neptune™ database, etc.

The computing devices may include communication lines or ports to enable the exchange of information with a set of networks (e.g., network 150) or other computing platforms via wired or wireless techniques. The network may include the Internet, a mobile phone network, a mobile voice or data network (e.g., a 5G or Long-Term Evolution (LTE) network), a cable network, a public switched telephone network, or other types of communications networks or combination of communications networks. The network 150 may include one or more communications paths, such as Ethernet, a satellite path, a fiber-optic path, a cable path, a path that supports Internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems 121-125 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of subsystems 121-125 may provide more or less functionality than is described. For example, one or more of subsystems 121-125 may be eliminated, and some or all of its functionality may be provided by other ones of subsystems 121-125. As another example, additional subsystems may be programmed to perform some or all of the functionality attributed herein to one of subsystems 121-125 described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “a element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, unless indicated otherwise, updating an item may include generating the item or modifying an existing time. Thus, updating a record may include generating a record or modifying the value of an already-generated value.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

The present techniques will be better understood with reference to the following enumerated embodiments:
1. A method comprising: obtaining data points in a feature space for a set of input records; determining explainability parameters for the data points and a prediction model using an explainability model; determining a score associated with a candidate data point of the data points based on a first set of values and a second set of values determined with the explainability parameters; selecting the candidate data point based on a result indicating that the score satisfies a threshold; and storing, in a memory, an indication of a candidate record associated with the candidate data point.
2. A method comprising: generating data points in a feature space for a set of input records, wherein the data points comprise feature values for a plurality of features in the feature space; determining explainability parameters for the data points and a prediction model using an explainability model, wherein each respective parameter of the explainability parameters is associated with a respective feature of the plurality of features; determining an entropy difference score based on the explainability parameters by comparing a first entropy value with a second entropy value, wherein the first entropy value is determined by providing an entropy model with a first subset of the explainability parameters associated with a first subset of the data points not comprising a candidate data point, and wherein the second entropy value is determined by providing the entropy model with a second subset of the explainability parameters associated with a second subset of data points comprising the candidate data point, and wherein the second subset of data points comprises the first subset of the data points; selecting the candidate data point based on a result indicating that the entropy difference score satisfies a threshold; and indicating a candidate record associated with the candidate data point as anomalous by updating a collection of anomalous records to comprise the candidate record.
3. A method comprising: generating data points in a feature space for a set of input records; determining explainability parameters for the data points and a prediction model using an explainability model, wherein each respective parameter of the explainability parameters is associated with a respective feature of a plurality of features in the feature space; determining a score associated with a candidate data point based on the explainability parameters by comparing a first value and a second value, wherein the first value is determined based on a first subset of the explainability parameters associated with a first subset of the data points, and wherein the second value is determined based on a second subset of the explainability parameters associated with a second subset of data points; selecting the candidate data point based on a result indicating that the score satisfies a threshold; and storing, in a memory, an indication of a candidate record associated with the candidate data point.
4. The method of any of embodiments 1 to 3, wherein the first value is a first entropy value, and wherein the second value is a second entropy value, further comprising: determining a first probability distribution for the first subset of the explainability parameters by binning each parameter of the first subset of the explainability parameters into a set of bins; determining a second probability distribution for the second subset of the explainability parameters by binning each parameter of the second subset of the explainability parameters into the set of bins; determining the first entropy value based on the first probability distribution; and determining the second entropy value based on the second probability distribution, wherein determining the score comprises determining a difference between the first entropy value and the second entropy value.
5. The method of embodiment 4, wherein determining the first entropy value comprises: obtaining a parameter value; determining a set of exponentials by using values of the set of bins as a base and using the parameter value as an exponent of the set of exponentials; and determining the first entropy value based on the set of exponentials.
6. The method of any of embodiments 1 to 5, wherein generating the data points comprises: obtaining an intermediate set of data points, wherein the intermediate set of data points comprises values of the set of input records; and dimensionally reducing the intermediate set of data points to generate the data points.
7. The method of any of embodiments 1 to 6, wherein determining the explainability parameters for the data points and the prediction model comprises determining a point-specific set of explainability parameters for a first data point, and wherein determining the point-specific set of explainability parameters for the first data point comprises: obtaining a default set of feature values; determining a path in the feature space from the default set of feature values to the first data point; determining a set of integrals by, for each respective feature of the feature space, determining a respective integral of partial derivatives with respect to the respective feature along the path; and determining the point-specific set of explainability parameters based on the set of integrals.
8. The method of any of embodiments 1 to 7, wherein determining the explainability parameters for the data points and the prediction model comprises determining a point-specific set of explainability parameters for a first data point, and wherein determining the point-specific set of explainability parameters for the first data point comprises: obtaining a set of feature value boundaries for a first feature of the feature space; perturbing the first feature within the set of feature value boundaries to determine a set of perturbation data points; determining a set of predictions by providing, as inputs, the prediction model with the set of perturbation data points; and determining an explainability parameter associated with the first feature for the first data point based on the set of predictions.
9. The method of any of embodiments 1 to 8, wherein determining the explainability parameters for the data points and the prediction model comprises determining a point-specific set of explainability parameters for a first data point, and wherein determining the point-specific set of explainability parameters for the first data point comprises: obtaining a kernel width in the feature space; perturbing feature values of the first data point within a feature space region defined by the kernel width to determine a set of perturbation data points; determining a set of predictions by providing, as inputs, the prediction model with the set of perturbation data points; and determining the point-specific set of explainability parameters based on the set of predictions.
10. The method of any of embodiments 1 to 9, wherein the prediction model comprises a tree-based model, wherein the explainability model comprises a tree-based SHAP model, and wherein determining the explainability parameters comprise: traversing the tree-based model along a plurality of paths to determine an initial set of Shapley values associated with nodes of the tree-based model; and determining parameter values of the explainability parameters by aggregating Shapley values of child nodes of the tree-based model with parent nodes of the tree-based model.
11. The method of any of embodiments 1 to 10, wherein the result is a first result, further comprising: determining a set of data point clusters based on the data points; and selecting the first subset of the data points based on a second result indicating that each respective data point of the first subset of the data points shared a shared data point cluster.
12. The method of claim 11, wherein determining the set of data point clusters comprises: obtaining a density parameter and a reference data point; determining a set of neighboring data points of the reference data point based on the density parameter; and associating each data point of the set of neighboring data points with a label of the reference data point to update the shared data point cluster to comprise the set of neighboring data points.
13. The method of any of embodiments 1 to 12, wherein the result is a first result, and wherein the threshold is a first threshold, and wherein selecting the candidate data point comprises: determining a first distance between the candidate data point and a second data point of the data points, wherein the first distance is in the feature space; determining a second distance between the candidate data point and the second data point of the data points, wherein the second distance is in an explainability parameter space of the explainability parameters; and selecting the candidate data point based on a second result indicating that the first distance is less than a second threshold and that the second distance is greater than a third threshold.
14. The method of any of embodiments 1 to 13, wherein determining the score comprises: determining a set of augmented data points by, for each respective data point of the data points, adding a respective subset of explainability parameters computed for the respective data point to feature values of the respective data point to form a respective augmented data point of the set of augmented data points, wherein: a first augmented data point of the set of augmented data points is associated with a first data point; the first set of values is represented by values of the first augmented data point; a second augmented data point of the set of augmented data points is associated with the candidate data point; and the second set of values is represented by values of the second augmented data point; and determining the score based on a distance between the first augmented data point and the second augmented data point.
15. The method of any of embodiments 1 to 14, the method further comprising: determining that a first record is missing a set of values; determining a neighboring set of records associated with the first record based on distances between a non-missing feature value of the first record and feature values of the neighboring set of records; determining a boundary region in the feature space for features of a missing set of values based on the neighboring set of records; and generating a subset of synthesized data points based on the first record and the boundary region, wherein the data points comprise the subset of synthesized data points.
16. The method of any of embodiments 1 to 15, wherein determining the explainability parameters for the data points and the prediction model comprises determining a point-specific set of explainability parameters for a first data point, and wherein determining the point-specific set of explainability parameters for the first data point comprises: determining a feature space region based on neighboring data points of the first data point; perturbing feature values of the first data point within the feature space region to determine a set of perturbation data points; determining a set of predictions by providing, as inputs, the prediction model with the set of perturbation data points; determining a set of marginal contributions based on the set of perturbation data points and the set of predictions; and determining the explainability parameters based on the set of marginal contributions.
17. The method of any of embodiments 1 to 16, wherein indicating the candidate record associated with the candidate data point comprises indicating a selected feature of the candidate record, wherein the selected feature is associated with a greatest explainability parameter of a subset of explainability parameters of the candidate data point.
18. The method of any of embodiments 1 to 17, wherein the data points are assigned to a shared data point cluster in the feature space.
19. The method of any of embodiments 1 to 18, the method further comprising: determining a first explainability parameter space cluster associated with a first subset of the data points; determining a second explainability parameter space cluster associated with a second subset of the data points, wherein the second subset of the data points comprises the candidate data point, wherein selecting the candidate data point comprises determining that the candidate data point is associated with an explainability parameter space cluster that is different from the first explainability parameter space cluster.
20. The method of any of embodiments 1 to 19, further comprising: detecting that the candidate data point has been updated to associate the candidate data point with a new label; and retraining the prediction model based on the candidate data point and the new label.
21. One or more tangible, non-transitory, machine-readable media storing instructions that, when executed by a set of processors, cause the set of processors to effectuate operations comprising those of any of embodiments 1-20.
22. A system comprising: a set of processors and a set of media storing computer program instructions that, when executed by the set of processors, cause the set of processors to effectuate operations comprising those of any of embodiments 1-20.

What is claimed is:

1. A system for detecting anomalous records using explainability-based entropy values, the system comprising one or more processors and a one or more media storing program instructions that, when executed by the one or more processors, cause the one or more processors to perform operations comprising:
generating data points in a feature space for a set of input records, wherein the data points comprise feature values for a plurality of features in the feature space;
determining explainability parameters for the data points and a prediction model using an explainability model, wherein each respective parameter of the explainability parameters is associated with a respective feature of the plurality of features;
determining an entropy difference score based on the explainability parameters by comparing a first entropy value with a second entropy value, wherein the first entropy value is determined by providing an entropy model with a first subset of the explainability parameters associated with a first subset of the data points not comprising a candidate data point, and wherein the second entropy value is determined by providing the entropy model with a second subset of the explainability parameters associated with a second subset of data points comprising the candidate data point, and wherein the second subset of data points comprises the first subset of the data points;
selecting the candidate data point based on a result indicating that the entropy difference score satisfies a threshold; and
indicating a candidate record associated with the candidate data point as anomalous by updating a collection of anomalous records to comprise the candidate record.

2. A method comprising:
generating data points in a feature space for a set of input records;
determining explainability parameters for the data points and a prediction model using an explainability model, wherein each respective parameter of the explainability parameters is associated with a respective feature of a plurality of features in the feature space;
determining a score associated with a candidate data point based on the explainability parameters by comparing a first value and a second value, wherein the first value is determined based on a first subset of the explainability parameters associated with a first subset of the data points, and wherein the second value is determined based on a second subset of the explainability parameters associated with a second subset of data points;
selecting the candidate data point based on a result indicating that the score satisfies a threshold; and
storing, in a memory, an indication of a candidate record associated with the candidate data point.

3. The method of claim 2, wherein the first value is a first entropy value, and wherein the second value is a second entropy value, further comprising:
determining a first probability distribution for the first subset of the explainability parameters by binning each parameter of the first subset of the explainability parameters into a set of bins;
determining a second probability distribution for the second subset of the explainability parameters by binning each parameter of the second subset of the explainability parameters into the set of bins;
determining the first entropy value based on the first probability distribution; and
determining the second entropy value based on the second probability distribution, wherein determining the score comprises determining a difference between the first entropy value and the second entropy value.

4. The method of claim 3, wherein determining the first entropy value comprises:
obtaining a parameter value;
determining a set of exponentials by using values of the set of bins as a base and using the parameter value as an exponent of the set of exponentials; and
determining the first entropy value based on the set of exponentials.

5. The method of claim 2, wherein generating the data points comprises:
obtaining an intermediate set of data points, wherein the intermediate set of data points comprises values of the set of input records; and
dimensionally reducing the intermediate set of data points to generate the data points.

6. The method of claim 2, wherein determining the explainability parameters for the data points and the prediction model comprises determining a point-specific set of explainability parameters for a first data point, and wherein determining the point-specific set of explainability parameters for the first data point comprises:
obtaining a default set of feature values;
determining a path in the feature space from the default set of feature values to the first data point;
determining a set of integrals by, for each respective feature of the feature space, determining a respective integral of partial derivatives with respect to the respective feature along the path; and
determining the point-specific set of explainability parameters based on the set of integrals.

7. The method of claim 2, wherein determining the explainability parameters for the data points and the prediction model comprises determining a point-specific set of explainability parameters for a first data point, and wherein determining the point-specific set of explainability parameters for the first data point comprises:
obtaining a set of feature value boundaries for a first feature of the feature space;
perturbing the first feature within the set of feature value boundaries to determine a set of perturbation data points;
determining a set of predictions by providing, as inputs, the prediction model with the set of perturbation data points; and
determining an explainability parameter associated with the first feature for the first data point based on the set of predictions.

8. The method of claim 2, wherein determining the explainability parameters for the data points and the prediction model comprises determining a point-specific set of explainability parameters for a first data point, and wherein determining the point-specific set of explainability parameters for the first data point comprises:
obtaining a kernel width in the feature space;
perturbing feature values of the first data point within a feature space region defined by the kernel width to determine a set of perturbation data points;
determining a set of predictions by providing, as inputs, the prediction model with the set of perturbation data points; and
determining the point-specific set of explainability parameters based on the set of predictions.

9. The method of claim 2, wherein the prediction model comprises a tree-based model, wherein the explainability model comprises a tree-based SHAP model, and wherein determining the explainability parameters comprises:
traversing the tree-based model along a plurality of paths to determine an initial set of Shapley values associated with nodes of the tree-based model; and
determining parameter values of the explainability parameters by aggregating Shapley values of child nodes of the tree-based model with parent nodes of the tree-based model.

10. The method of claim 2, wherein the result is a first result, further comprising:
determining a set of data point clusters based on the data points; and
selecting the first subset of the data points based on a second result indicating that each respective data point of the first subset of the data points shared a shared data point cluster.

11. The method of claim 10, wherein determining the set of data point clusters comprises:
obtaining a density parameter and a reference data point;
determining a set of neighboring data points of the reference data point based on the density parameter; and
associating each data point of the set of neighboring data points with a label of the reference data point to update the shared data point cluster to comprise the set of neighboring data points.

12. A set of non-transitory, machine-readable media storing program instructions that, when executed by one or more processors, causes the one or more processors to perform operations comprising:
obtaining data points in a feature space for a set of input records;
determining explainability parameters for the data points and a prediction model using an explainability model;
determining a score associated with a candidate data point of the data points based on a first set of values and a second set of values determined with the explainability parameters;
selecting the candidate data point based on a result indicating that the score satisfies a threshold; and
storing, in a memory, an indication of a candidate record associated with the candidate data point.

13. The set of non-transitory, machine-readable media of claim 12, wherein the result is a first result, and wherein the threshold is a first threshold, and wherein selecting the candidate data point comprises:
determining a first distance between the candidate data point and a second data point of the data points, wherein the first distance is in the feature space;
determining a second distance between the candidate data point and the second data point of the data points, wherein the second distance is in an explainability parameter space of the explainability parameters; and
selecting the candidate data point based on a second result indicating that the first distance is less than a second threshold and that the second distance is greater than a third threshold.

14. The set of non-transitory, machine-readable media of claim 12, wherein determining the score comprises:
determining a set of augmented data points by, for each respective data point of the data points, adding a respective subset of explainability parameters computed for the respective data point to feature values of the respective data point to form a respective augmented data point of the set of augmented data points, wherein:
a first augmented data point of the set of augmented data points is associated with a first data point;
the first set of values is represented by values of the first augmented data point;
a second augmented data point of the set of augmented data points is associated with the candidate data point; and
the second set of values is represented by values of the second augmented data point; and
determining the score based on a distance between the first augmented data point and the second augmented data point.

15. The set of non-transitory, machine-readable media of claim 12, the operations further comprising:
determining that a first record is missing a set of values;
determining a neighboring set of records associated with the first record based on distances between a non-missing feature value of the first record and feature values of the neighboring set of records;
determining a boundary region in the feature space for features of a missing set of values based on the neighboring set of records; and
generating a subset of synthesized data points based on the first record and the boundary region, wherein the data points comprise the subset of synthesized data points.

16. The set of non-transitory, machine-readable media of claim 12, wherein determining the explainability parameters for the data points and the prediction model comprises determining a point-specific set of explainability parameters for a first data point, and wherein determining the point-specific set of explainability parameters for the first data point comprises:
determining a feature space region based on neighboring data points of the first data point;
perturbing feature values of the first data point within the feature space region to determine a set of perturbation data points;
determining a set of predictions by providing, as inputs, the prediction model with the set of perturbation data points;
determining a set of marginal contributions based on the set of perturbation data points and the set of predictions; and
determining the explainability parameters based on the set of marginal contributions.

17. The set of non-transitory, machine-readable media of claim 12, wherein indicating the candidate record associated with the candidate data point comprises indicating a selected feature of the candidate record, wherein the selected feature is associated with a greatest explainability parameter of a subset of explainability parameters of the candidate data point.

18. The set of non-transitory, machine-readable media of claim 12, wherein the data points are assigned to a shared data point cluster in the feature space.

19. The set of non-transitory, machine-readable media of claim 12, the operations further comprising:
determining a first explainability parameter space cluster associated with a first subset of the data points; and
determining a second explainability parameter space cluster associated with a second subset of the data points, wherein the second subset of the data points comprises the candidate data point, wherein selecting the candidate data point comprises determining that the candidate data point is associated with an explainability parameter space cluster that is different from the first explainability parameter space cluster.

20. The set of non-transitory, machine-readable media of claim 12, further comprising:
detecting that the candidate data point has been updated to associate the candidate data point with a new label; and
retraining the prediction model based on the candidate data point and the new label.
